(19) United States
(12) Patent Application Publication
(10) Pub. No.: US 2012/0183135 A1
(43) Pub. Date: Jul. 19, 2012

(54) RELIABLE PUF VALUE GENERATION BY PATTERN MATCHING

(75) Inventors: Zdenek Paral, San Jose, CA (US); Srinivas Devadas, Lexington, MA (US)

(73) Assignee: Verayo, Inc., Palo Alto, CA (US)

(21) Appl. No.: 13/009,205

(22) Filed: Jan. 19, 2011

(51) Int. Cl. H04L 9/06

(52) U.S. Cl. 380/44

(57) ABSTRACT

A method is used to reliably provision and re-generate a finite and exact sequence of bits, for use with cryptographic applications, e.g., as a key, by employing one or more challengeable Physical Unclonable Function (PUF) circuit elements. The method reverses the conventional paradigm of using public challenges to generate secret PUF responses; it exposes the response and keeps the particular challenges that generate the response secret.

### BACKGROUND

This invention relates to use of pattern matching with Physical Unclonable Functions (PUFs) to repeatedly and reliably generate keys or other secrets values in a device.

An important aspect of improving the level of trustworthiness of semiconductor devices, semiconductor based systems, and semiconductor supply chain relates to enhancing physical security. Not only do we want semiconductor devices to be resistant to computational attacks, but also to physical attacks. Physical Unclonable Functions (PUFs) are becoming a useful tool in this regard.

Silicon PUFs generate signatures based on device manufacturing variations which are difficult to control or reproduce. Given a challenge as input, a PUF outputs a response that is unique to the manufacturing instance of the PUF circuit. These responses are similar, but not necessarily bit exact, when regenerated on a given device using the given challenge, and are expected to deviate more in Hamming distance from a reference response as environmental parameters (for example, temperature and voltage) deviate between provisioning and regeneration. For instance, this is because circuit delays do not vary uniformly with temperature and voltage.

There are two broad classes of applications for PUFs. In certain classes of authentication applications, the silicon device is authenticated if the regenerated response is “close enough” in Hamming distance to the provisioned response. Errors in PUF responses are forgiven up to a certain threshold. In an authentication application, not repeating challenges prevents replay attacks. The PUF should be resistant to software model building attacks (e.g., machine learning attacks) in order to be secure, because otherwise an adversary can create a software model or clone of a particular PUF. A second class of applications is secret key generation. In conventional usage of a PUF as a key generator, only a fixed number of secret bits need to be generated from the PUF. These bits can be used as symmetric key bits or used as a random seed to generate a public/private key pair in a secure processor. However, in order for the PUF outputs to be usable in cryptographic applications, the noisy bits need to be error corrected, with the aid of helper bits, commonly referred to as a Helper data. The greater the environmental variation a PUF is subject to, the greater the possible difference (noise) between a provisioned PUF response and a re-generated response.

This conventional method of PUF key generation using PUF response bits as secret keys has been explored in many publications. Error correction should be secure, robust and efficient. A security concern is the leakage of secret bits through the Helper data or helper bits. Robustness requires that the number of corrected errors be equal to greater than the maximum number of bit-errors from the widest range of environmental variation expected. Previously proposed schemes have used relatively heavyweight error correction logic, for instance using a BCH decoder that is capable of correcting several bit-errors in a 64-bit codeword.

### SUMMARY

In one aspect, in general, a novel method is used to reliably provision and re-generate a finite and exact sequence of bits, for use with cryptographic applications, e.g., as a key, by employing one or more challengeable Physical Unclonable Function (PUF) circuit elements. The method reverses the conventional paradigm of using public challenges to generate secret PUF responses; it exposes the response and keeps the particular challenges that generate the response secret.

In some examples, a key is assembled from a series of small (e.g., initially chosen or random), secret integers, each being an index into a string of bits produced by the PUF circuit(s). A PUF unique pattern at each respective index is then persistently stored between provisioning and all subsequent key re-generations. To obtain the secret integers again, a newly repeated PUF output string is searched for high probability matches with the stored patterns. This means that complex error correction logic such as BCH decoders are not required. The method reveals only relatively short PUF output data in public store, thwarting opportunities for modeling attacks.

In another aspect, in general, a method for secret key generation uses PUF in a novel way. Rather than using a fixed (possibly) public challenge and keeping the response bits secret, we reverse the paradigm and keep the particular challenges that generate exposed response bits secret. The secret key can be chosen at random. Roughly, the method works as follows: A PUF beginning from a fixed public challenge generates a string of response bits of length L. A secret integer s of bit-size N=log₂(L) is treated as an index into the string L. Beginning with that index, a W<L-length pattern of PUF outputs is exposed and stored in non-volatile storage. This is the provisioning step. During key re-generation, the W-length pattern is provided to the PUF, and the PUF begins internally generating its output string. In the simplest instantiation, comparison logic looks for the pattern in the output string, allowing for some mismatches. If an approximate match with mismatches equal to or less than T bits is found, then the associated index for the match is s, which is correct with a very high probability. To generate a K-bit secret, we can run the above scheme K/log₂(L) times.

In another aspect, in general, a method is used to securely maintaining a secret value based on device-specific characteristics of a device. The method includes first accepting the secret value. A device-specific pattern sequence is generated in the device in a first phase. The pattern sequence is statistically unique to the device. One or more offset values are selected to represent the secret value, and selected patterns in the pattern sequence at the selected offset values are determined. The selected patterns are provided for maintenance in a storage associated with the device for use in subsequent regeneration of the secret value.

Aspects may include one or more of the following.

Generating the device specific pattern sequence comprises generating a bit sequence, wherein the patterns of the pattern sequence represent segments of the bit sequence.

Generating the device specific pattern sequence comprises applying a sequence of inputs to a Physical Unclonable Function (PUF) module, and forming the devices specific pattern sequence from the corresponding outputs of the PUF module.

The method further includes accessing the maintained selected patterns from the storage associated with the device, and in the device in second phase, regenerating a device-specific pattern sequence, the patterns in the sequence being statistically similar to the patterns generated in the device in the first phase. For each of the selected patterns from the storage, an offset in the regenerated pattern sequence is determined at which the regenerated pattern corresponds to the pattern accessed from the storage. The secret value is formed from the determined offset of each of the maintained selected patterns.

Determining the offset in the regenerated pattern sequence at which the regenerated pattern corresponds to the pattern accessed from the storage includes determining whether the regenerated pattern matched the pattern from the storage within a predetermined degree of difference.

The patterns are represented as bit sequences, and the predetermined degree of difference comprised as predetermined number of bit differences.

The method further includes forming a plurality of parts of the secret value, and wherein each of the selected one or more offsets represents a different part of the secret value.

Generating the device specific pattern sequence comprises applying a sequence of inputs to a Physical Unclonable Function (PUF) module, and forming the devices specific pattern sequence from the corresponding outputs of the PUF module.

The sequence of inputs depends on one or more parts of the secret value.

The secret value comprises a cryptographic key. For instance, the cryptographic key comprises a symmetric key, an asymmetric key, and/or a private key.

The method further includes using the cryptographic key to perform a function on the device.

In another aspect, in general, a method is used for securely regenerating a secret value based on one or more maintained patterns. The method includes accessing the maintained selected patterns from a storage associated with the device. In the device, a device-specific pattern sequence is regenerated, the patterns in the sequence being statistically similar to patterns of a prior pattern sequence generated in the device. For each of the selected patterns from the storage, an offset in the regenerated pattern sequence is determined at which the regenerated pattern corresponds to the pattern accessed from the storage. The secret value is formed from the determined offset of each of the maintained selected patterns.

In another aspect, in general, a circuit module includes: a pattern sequence generator for repeatedly generating a pattern sequence that is statistically unique to the device; a pattern selector configured to accept a secret value, and select patterns in the pattern sequence according to one or more offsets determined from the secret value; an interface for storing the selected patterns, and subsequence retrieval of the selected patterns; a pattern matcher configured to retrieve the selected patterns and to determine offsets of the one or more patterns in a repeated generation of the pattern sequence; and a value assembler for combining the determined offsets to assemble a regeneration of the secret value.

In another aspect, in general, a software description of a circuit module comprises data embodied on a tangible machine readable medium for causing a processor to assemble the module into a device description. The circuit module includes: a pattern sequence generator for repeatedly generating a pattern sequence that is statistically unique to the device; a pattern selector configured to accept a secret value, and select patterns in the pattern sequence according to one or more offsets determined from the secret value; an interface for storing the selected patterns, and subsequence retrieval of the selected patterns; a pattern matcher configured to retrieve the selected patterns and to determine offsets of the one or more patterns in a repeated generation of the pattern sequence; and a value assembler for combining the determined offsets to assemble a regeneration of the secret value.

Advantages of one or more embodiments include only requiring comparison logic, which is very efficient from a hardware standpoint. The parameters L, W and T may be chosen so the probability of a collision (i.e., a different index being returned) and the probability of no match (all patterns have more than T mismatches) are negligible under prescribed environmental variation. The security of the scheme is based on the assumption that it is hard to construct a model of PUF behavior given a (limited) number of challenge-response relationships.

Another advantage arises from the limited hardware requirements of the approach: only a PUF, registers, bit-comparison, and threshold computation logic is required. The generation of keys can be made faster and the security-level raised by increasing the number of PUFs.

Other features and advantages of the invention are apparent from the following description, and from the claims.

### DESCRIPTION OF DRAWINGS

FIG. 1A is a block diagram of a key generator in a provisioning mode, and FIG. 1B is a block diagram of the key generator in a re-generating mode.

FIG. 2 is a block diagram of and embodiment of a Pattern Matching Key Generator (PMKG).

FIG. 3A is a graph showing inter- and intra-chip code distance distribution, and

FIG. 3B is a graph showing detection tolerance.

FIG. 4A is a block diagram of an device in an encoder mode, and FIG. 4B is a block diagram of the device in a decoder mode.

FIG. 5 is multiple value encoder/decoder.

FIG. 6 is an example of a device that includes an integrated key generator and multiple value encoder/decoder for a generated key.

### NOTATION

The following notation is generally followed in the description below. Example values, which may be used in one or more embodiments are also provided.

| Metric | Symbol | Example | Note |
|---|---|---|---|
| Key size | K | 128 | |
| Challenge size | C | 64 | |
| PUF count | P | 1 | |
| Blender ratio | B | 4 | input-bits/output-bit |
| Pattern width | W | 256 | |
| Round length | L | 1024 | |
| Round count | R | 16 | $R \geq \frac{K}{N}$ |
| Match threshold | T | 80 | Tolerance |
| Secret index size | N | 10 | N = log₂(L) |
| Key mixer count | M | 2 | $M = \frac{K}{C}$ |
| Clocks per round | CPR | 5,120 | $CPR = \frac{( L + W ) \times B}{P}$ |
| Clocks total | CT | 81,920 | CT = R × CPR |
| Entropy size | E | 160 | E = R × N |
| Total pattern size | S | 4,096 | S = W × R |

### DESCRIPTION

### 1. Overview

Generally, one or more embodiments described below address the technical problem of repeatedly generating a value in a device, without requiring storing of the generated value (or any other value from which the secret value may be determined) in a non-volatile storage on or off the device, thereby preventing the value from being exposed. Such a value may be used, for example, directly as part of a secret cryptographic key, as an input to a deterministic function that computes such a key, or in other cryptographic and/or authentication applications. In some examples, the value may be provided to the device or may be initially chosen within the device at random.

Rather than using a fixed (possibly) public challenge and keeping the response bits secret, the paradigm is reversed by keeping the particular challenges that generate exposed response bits secret. Roughly, an example of the method works as follows: A PUF beginning from a fixed public challenge generates a string of response bits of length L. A secret integer s of bit-size log₂(L) is treated as an index into the string L. Beginning with that index, a W<L-length pattern of PUF outputs is exposed and stored in non-volatile storage (e.g., either on the device or in an off-device storage).

During key re-generation, the pattern is retrieved from the storage, and the PUF begins internally re-generating its output string, again beginning from the fixed public challenge used during provisioning. In the simplest instantiation, comparison logic looks for the pattern in the output string, allowing for some mismatches. If an approximate match with bit mismatches equal to or less than T is found (with some probability) then the associated index for the match is s. To generate a K-bit secret, we can run the above scheme K/log₂(L) times.

### 2. Example Embodiment

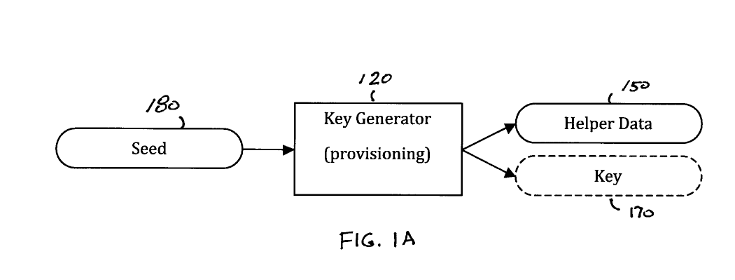

Referring to FIG. 1A, in an example embodiment, at provisioning time, a key generator 120 takes an externally provided (secret) Seed 180 (entropy for the generated Key) and, using its embedded PUF, encodes this Seed into a (public) Helper data 150 and a (secret) Key 170. The Seed is only input once and may be discarded; the Helper data is (publicly) stored for later use during Key re-generation; the (secret) Key is discarded.

Referring to FIG. 1B, the key generator 120 reliably produces the earlier provisioned Key 170, given the corresponding Helper data 150. The key generator combines the Helper data with its unique, unclonable hardware PUF function, so that only the presence of both the hardware circuit and the Helper data leads to the correct Key, while the Helper data alone does not reveal any usable information about the Key.

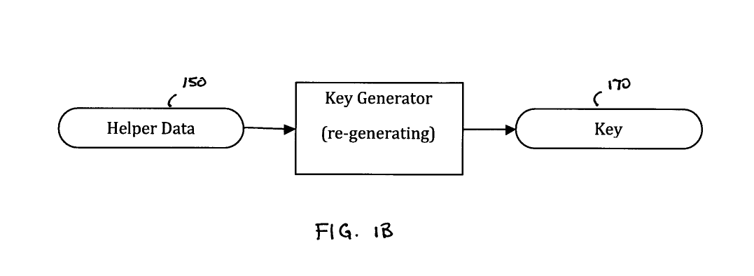

The architecture of an example of a Pattern Matching Key Generator (PMKG) 200 is shown in FIG. 2. Besides control logic, which is not illustrated, the PMKG consists of the following components:
Re-startable, Bi-modal Challenge Sequence Generator 220: This is usually a linear-feedback shift register (LFSR) with an associated primitive polynomial. The sequence generator has a single input that affects the generated sequence.
One or more Challengeable Physical Unclonable Function modules 210. For example, each module 210 includes a delay-based PUF as described in U.S. Pat. No. 7,757,083, titled “Integrated Circuit That Uses A Dynamic Characteristic Of The Circuit,” issued on Jul. 13, 2010.
PUF Output Blender 212: For security against modeling attacks, we require multiple Arbiter PUF outputs to be blended into a single bit. 4 bits are XOR'ed together corresponding to a 4-XOR Arbiter PUF.
Pattern Shift Register 230 of length W.
Tolerant Pattern Match Detector 240: The detector fires if the pattern in the Pattern Shift Register is within the threshold T of the selected pattern in the Persistent Helper data Store.
Persistent Helper data Store 250 and Pattern Selector: Patterns for each round are stored in the Helper data Store during provisioning.
Additional Bi-modal Key Mixer(s) 260: The key can be obtained directly from the index of the challenge sequence generator or mixed. Volatile Key Store (e.g., SRAM) 270

The key generator works in rounds. A round is an instance of generating O bits (O=L+W) of continuous, blended PUF data; there are L possible patterns of width W found in such data. The position of such pattern is represented by its (zero-based index) I, which is N bits wide for binary power round lengths (L=2^{N}).

During provisioning, for each round, a secret index is selected. Blended PUF output bits of length W beginning from the appropriate index are loaded into non-volatile memory. Multiple bits are blended by the PUF Blender, for example, four PUF output bits (from a single or multiple PUFs) may be XOR'ed together to generate a blended PUF output bit. This blending improves security as is discussed in Section 3.

Assume now that the PMKG has been provisioned. During key re-generation, the PMKG works in multiple rounds, each consisting of a fixed-length challenge sequence. The challenge sequence generator is a linear feedback shift register (LFSR) with an associated primitive polynomial, and begins from the fixed challenge. PUFs generate response bits based on the applied challenge. The blended outputs are shifted into a pattern shift register and the Tolerant Match Detector matches the first pattern against the contents of the pattern shift register. If the number of mismatches is This should <=T, not the subset symbol ≦T, the match signal is raised. At the end of the round, the index of the challenge that caused the match is loaded into the Volatile Key Store. If there is no match in a round, we have a failure. We note that the PMKG takes exactly the same number of cycles and performs exactly the same number of operations each round to generate any key. Thus, it is less susceptible to differential power or timing analysis.

### 2.1 Bi-Modality

The match signal in FIG. 2 is used to indicate that the index corresponding to the key has been found. In some embodiments, it is also used to “fork” the challenge sequence. This has several advantages:

Security is enhanced. Since the index that is matched on is secret, each round makes the actual challenge sequence less and less traceable to an outsider/attacker, at a multiplicative rate of L per round.

It is consistent with running the challenge sequencer for a fixed number of cycles each round.

Forking in the challenge sequencer is set up in such a way that at the end of the round, the matching secret index can be deterministically derived from the LFSR contents.

Let us further define CS(c, a, f) as the challenge sequencing function with the starting challenge c, number of advancements a, and sequence-forking flag f. The forking flag f is cleared at the beginning of every round, and set upon finding a pattern match between the round's Helper data and the current blended PUF data. The challenge sequencing is therefore split into two parts, one “before match” and “at and after match”. Note that the “before match” part may be of zero length. If no match were found (a fault condition), the resulting challenge value would be composed as cᵣ₊₁(no_match)=CS(cᵣ, L, 0), for the sequence that started with the challenge cᵣ, advanced L times, with the forking flag cleared during the whole round. Under non-faulty conditions, a Helper data pattern match is made at some index Iᵣ, setting the forking flag f for the rest of the round. Resulting challenge can be composed from the concatenated sequencing operations, cᵣ₊₁=CS(cᵣₘ, L−Iᵣ,1), where cᵣₘ=CS(cᵣ, Iᵣ, 0).

Alternatively, the challenge sequence could be split into three parts, one “before match”, one “at match”, and one “after match”, whereby the flag is only set in the single-advancement “at match” phase.

### 2.2 Failures and Reliability

The PUF output data are not fully repeatable, which is usually exaggerated by the blending function (e.g., XOR), and there is no guarantee that this key generator can always converge to the same key, despite and/or because of the forgiving nature of the noise-tolerant pattern matching logic. We have two possible failure conditions: pattern misses and pattern collisions.

### 2.2.1 Pattern Miss

A miss occurs if the PUF generated data contain so much noise that it differs too much from the Helper data block and the match detector does not fire at all during a round, which is detectable by the control logic at the end of each round. Frequent misses indicate that the threshold T is set too low and should be increased. Pattern misses can be thought of as false negatives.

### 2.2.2 Pattern Collision

A collision occurs if the PUF generated data happens to come too close to matching a Helper data block originated by a different secret index within the round. This error results in an incorrect recapture of the secret index and subsequent catastrophic divergence from the provisioned challenge scheduling case of the bi-modal challenge sequence generator. Unlike the pattern miss, it is undetectable at the control level. If collisions occur, it means that the threshold T is set too high. Pattern collisions can be thought of as false positives.

The best defense against the above failures lies in choosing sufficiently wide pattern (W), so that the probabilities of misses and collisions decrease to miniscule levels with appropriate choice of T. This is the approach we take in Section 5.

In implementations where wide patterns can be traded for time, partial (miss) and full (collision) retrials with error detection can be employed. For example, a one way (hash) function slaved to the challenge sequencer produces a digest that is compared with a hash value stored at provisioning time; a match indicates a high probability of correct key generation. A narrow pattern retrial approach needs additional logical support at provisioning time, as the index choices must be discriminated for stability, and rejected if found unable to perform within acceptable number of re-tries.

### 3. Security Considerations

We are exposing response data of the PUF. In authentication applications, it is assumed that even given unlimited challenge-response pairs (CRPs), the adversary is unable to create the model of the underlying PUF or successfully predict the response for a new challenge. A circuit for which it is currently impossible to create a software model for is called a Strong PUF. Recent work has determined that several architectures that were previously considered Strong PUFs are, in fact, clonable via machine learning attacks. This is similar to traditional cryptography, where many encryption and hashing algorithms once considered secure are now broken. One architecture that is resistant to machine learning attacks is a k-XOR n-stage Arbiter PUF with k>6 and n=64. However, the number of CRPs required to successfully attack k-XOR PUFs grows rapidly with k. For a 4-XOR Arbiter PUF with error-inflicted CRPs, over 30,000 CRPs are required, and for a 5-XOR 128-stage PUF over 100,000 CRPs are required. We note that we cannot arbitrarily increase k, since the noise levels increase with k.

In PMKG, CRPs are not exposed directly, but the adversary knows all the details of the PMKG architecture including the beginning fixed challenge. The number of exposed response bits is the Helper data size, which can be assumed to be 4096. This is much smaller than the number of CRPs required for modeling. We have two means of increasing the complexity seen by the adversary.

For small additional circuit area, the number of PUFs P can be increased and the effective response size that is exposed per PUF (or set of PUFs) can be reduced by a factor of P.

The second way is to not expose the challenge sequence schedule to the adversary. As described above, the occurrence of a match at a particular index affects the challenge schedule in the subsequent round. Since the matching index is secret, constructing possible CRPs becomes more and more difficult with each passing round. In effect, this reduces the number of CRPs available to the adversary.

We describe two possible strategies for provisioning: (1) The manufacturer and provisioning entity are trusted, or (2) The manufacturer is trusted to fabricate the design, and anyone in possession of the chip can provision a new secret with the guarantee that it cannot be discovered.

Strategy (1) requires that the provisioning mode be disabled when the chip is in the field, for example, through an irreversible “fuse” operation. This is often assumed when PUFs are used to generate a fixed-length response that is used as a key (e.g., ring oscillator bits or SRAM bits). The same strategy can be employed with PMKG as well.

Strategy (2) requires more hardware functionality in the chip. In the conventional case of the PUF response being secret, one can imagine using a PUF to generate a “fixed” response string and built-in error encoding functionality. (Only on-chip error decoding is required in (1).) produces a syndrome for the PUF response string and stores it in nonvolatile memory. The PUF response is never exposed, and is used to merely encrypt and decrypt secondary keys. Any entity can provision a secondary key that is stored in encrypted form in persistent storage. In the field, the PUF chip internally decrypts the secondary key upon power-up. Trying to provision again may generate a slightly different key and a different syndrome and is not a security concern provided secure error correction schemes are used. In the PMKG case, we can use a separate PUF or the same PUF with a different challenge to generate a secret, and use the secret as the Seed input to the PMKG during provisioning. Note that the PMKG is an encoder as well as a decoder, and so does not have to change. Upon repeated provisioning, the Seed may vary slightly and generate slightly different pattern data, but remains unknown, as does the Key derived from down-mixing the Seed. The PMKG is constructed with large enough PUF count P such that exposing multiple sets of (similar) patterns does not compromise resilience against modeling attacks.

### 4. Related Work

### 4.1 Physical Unclonable Functions (PUFs)

Pappu (R. Pappu, “Physical one-way functions,” Ph.D. dissertation, Massachusetts Institute of Technology, 2001) described Physical One-Way Functions implemented using microstructures and coherent radiation and described an authentication application. Gassend et al (B. Gassend, D. Clarke, M. van Dijk, and S. Devadas, “Silicon physical random functions,” in Computer and Communication Security Conference, 2002) coined the term Physical Unclonable Function and showed how PUFs could be implemented in silicon, and used for authentication as well as cryptographic applications. Many other silicon realizations of PUFs have been proposed.

It has been shown that some proposed PUFs can be modeled or reverse-engineered precluding their use in unlimited authentication applications. Recent work related to numerical modeling attacks on PUFs and is discussed in Section 3.

### 4.2 Error Correction

In a typical error correction setting for PUF, during an initialization phase, the PUF is evaluated for a set of challenges. Then a Helper data is computed based on the responses. The Helper data or helper data is public information which is later sent to the PUF along with the challenges to perform correction on response bits. Equivalently, the Helper data can be stored locally on chip. Early work employed 2D hamming codes for error correction, and later work proposed use of Bose-Chaudhuri-Hochquenghen (BCH) codes for error correction on PUF responses. In particular, the use of BCH(255, 63, t=30) code was proposed, where 255 PUF response bits are mapped to a 63-bit key with a 192-bit Helper data. The code is capable of correcting maximum 30 erroneous responses bits. However, the implementation cost and hardware overhead of this code is significantly high and becomes even impractical as the number of errors in responses increases.

Since the Helper data is public information, the adversary can derive bias information from the Helper data to tighten the search space to find the secret key. Information leakage via Helper data is a critical aspect of the error correction. Note that previous uses of Helper data corresponded to using PUF response bits as secret key bits. In one or more embodiments of the present approach, indices into PUF challenge bits are used as the secret key bits, and the PUF response is exposed. In some embodiments, a PUF with the properties that have been termed a “Strong” PUF. In other embodiments, we can weaken the adversary to only knowing a relatively small set of PUF response bits.

### 5. Evaluation Using ASIC Data

We evaluated the PMKG approach described above on data obtained from 4-XOR and higher Arbiter PUFs. We focused on 4-XOR Arbiters in our experiments.

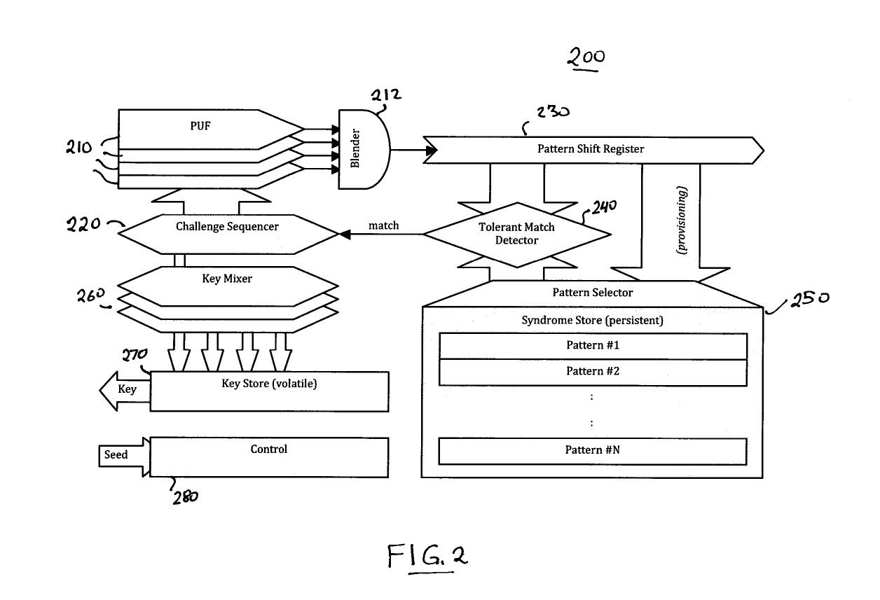

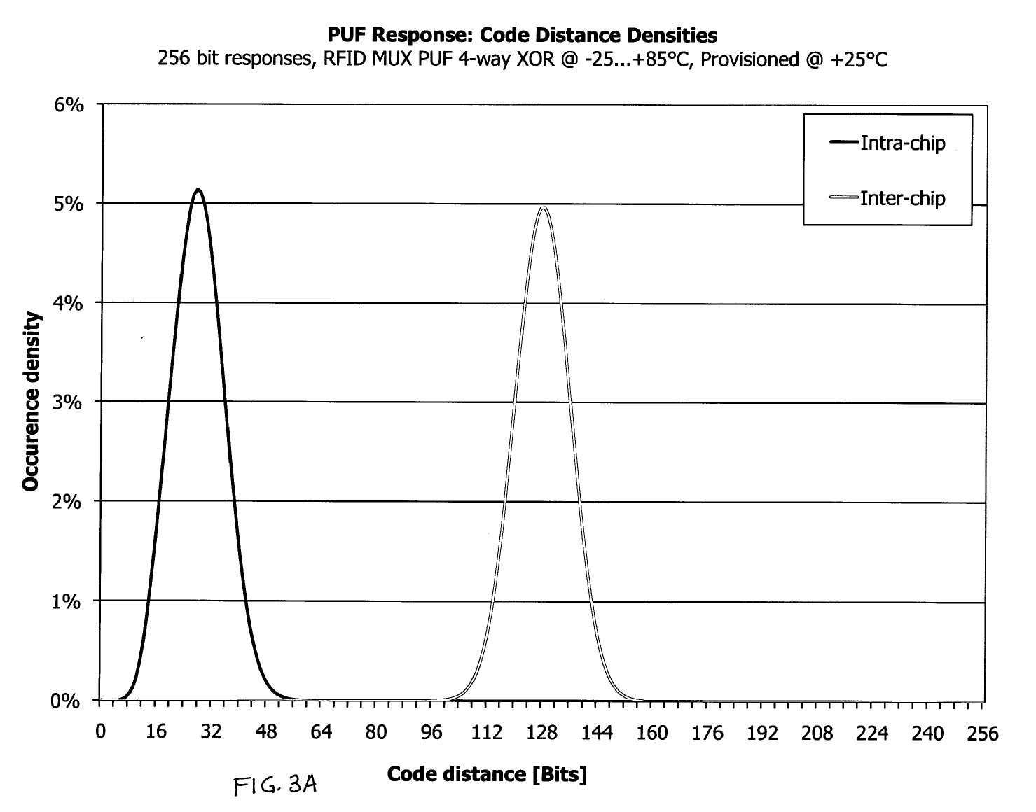

We first provide results on inter-chip and intra-chip variation of ten 4-XOR Arbiter chips in FIG. 3A. The PUF chips were provisioned at 25° C. and response re-generation was done between −25° C. and +85° C. in an TestEquity HalfCUBE (Model 105A) Oven with switching between −25° C., +25° C., and +85° C. We note that the PUF is receiving power from an RFID reader and therefore there is voltage variation across provisioning and re-generation, but it cannot be quantified precisely. FIG. 3B shows that the inter-chip variation is very close to 50%, and the average intra-chip variation is 5%. FIG. 3B gives the false positive and false negative rates for various thresholds. If we choose a threshold of 80, the false positive and negative rates are both less than 1 part per billion (the point where the curves intersect is below 0.001 ppm).

We next provide results on key provisioning and re-generation. Five 4-XOR Arbiter chips were provisioned at 25° C. and response re-generation was done between −25° C. and +85° C. with switching between −25° C., +25° C., and +85° C. We used four settings for W and T: W=96, T=24, W=128, T=36, W=192, T=54, and W=256, T=80. For each of the four settings of W and T, keys were re-generated over 18,500 times across the temperature range.

If key re-generation fails, we retry up to 19 total times. For example, W=96, T=24 resulted in only 14,003 out 18,540 successful key re-generation in the first trial, and in 94 cases, 19 trails were not enough. On the other hand, W=256, T=80 was successful in the very first trial 100% of the time.

Our results indicate that we require W≧128, and the specific choice will depend on the trading off key generation time (including possible retrials) for Helper data size.

### 6. Implementations and Alternative

We have presented a viable method of PUF key generation that differs significantly from previous proposals.

In order for the exposed responses to not be a security hazard we had to use a 4-XOR arbiter PUF. Other forms of delay PUF structures that are hard to model and have less intrinsic noise than a 4-XOR arbiter PUF may be used in other implementations.

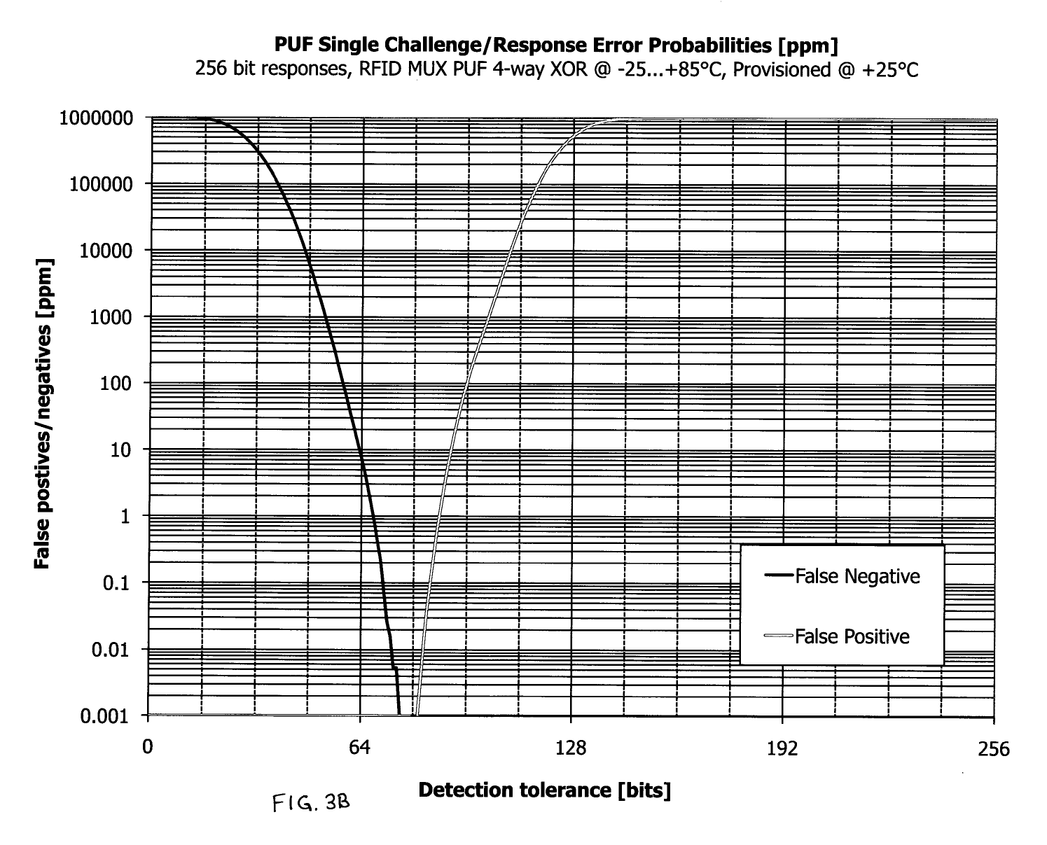

In alternative embodiments, the approach described above may be used to securely store other quantities. Referring to FIGS. 4A-B, a module 400, which may be integrated within a device is used to encode a secret value, and later decode one or more stored patterns to regenerate the secret value, for example, for use only within the device hosting the module without storing the secret value in a non-volatile storage or disclosing the secret outside the device. In an encode mode, the module 400 accepts a challenge c and a secret s, and produces a pattern p, which may be stored in an exposed manner. The challenge c is passed to a sequence generator, for example, an LFSR 420, which generates a challenge sequence cs. Preferably, the sequence generator 420 is also responsive to the secret s in that at least part of the sequence cs is different for different values of s. The challenge sequence cs is passed to a PUF module 410, which produces a device specific pseudo-random result sequence rs, which provides a way to determine L patterns (r₀, r₁, . . . , r_{L-1}). In some examples, as described above, the patterns form overlapping W bit sections of an L+W long result sequence. In other examples, the patterns do not necessarily have to be overlapping, and the exposed patterns may be functions (e.g., difficult to invert functions) of sections of the result sequence. The N≦log_{w}(L) bit secret s (treated as an integer) is passed to an expose module 445, which selects the pattern rₛ, which is provided as the output pattern p.

Referring to FIG. 4B, in a decode mode, the module 400 accepts the same challenge c and the pattern p, which was previously produced by the device. The sequence generator 420 produces a challenge sequence cs using the same procedure as during encoding. The device determines a reconstructed secret ŝ. Assuming that the challenge sequence cs is the same as the challenge sequence cs during encoding, the result sequence provides a sequence of L patterns (\tilde{r}₀, \tilde{r}₁, . . . , \tilde{r}_{L-1}). Each pattern \tilde{r}ⱼ is not necessarily exactly the same as rⱼ but is expected to be statistically close. The pattern sequences generated by the device are statistically unique to the device in that although not necessarily identical on each regeneration of the sequence, the patterns are extremely unlikely to be generated by other devices as compared to the expected variability of the patterns (e.g., bit flips) using the same device. A match module 440 accepts the previously produced and stored pattern p, and provides the index of a matching pattern such that \tilde{r}_{ŝ}≈p=rₛ. In some examples, there is an absolute criterion (e.g., number of bits matching) that must be satisfied by exactly one pattern. In other examples, a best matching pattern index is returned as ŝ. Note that the challenge sequence generator cannot depend on s in such a manner that the challenge sequence cannot be determined before ŝ is found.

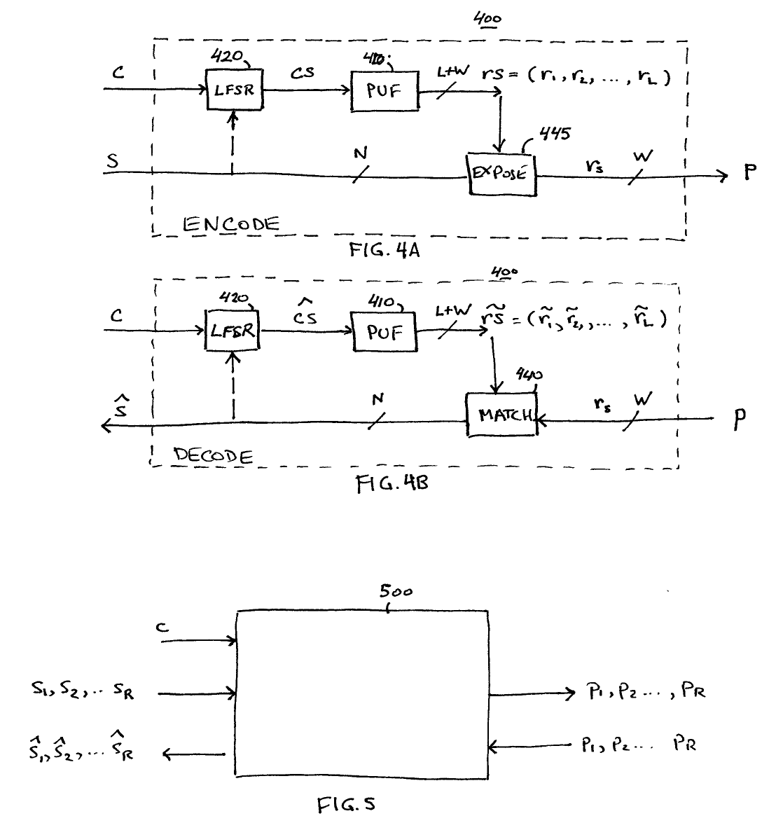

Referring to FIG. 5, a module 500 applies the approach described above to encode a series of secrets s₁, s₂, . . . (which may represent parts of a larger secret value) into a corresponding series of patterns p₁, p₂, . . . , and uses those patterns to regenerate the secrets as ŝ₁, ŝ₂, . . . , which match the input secrets only if the same instance of the module is used to decode the patterns.

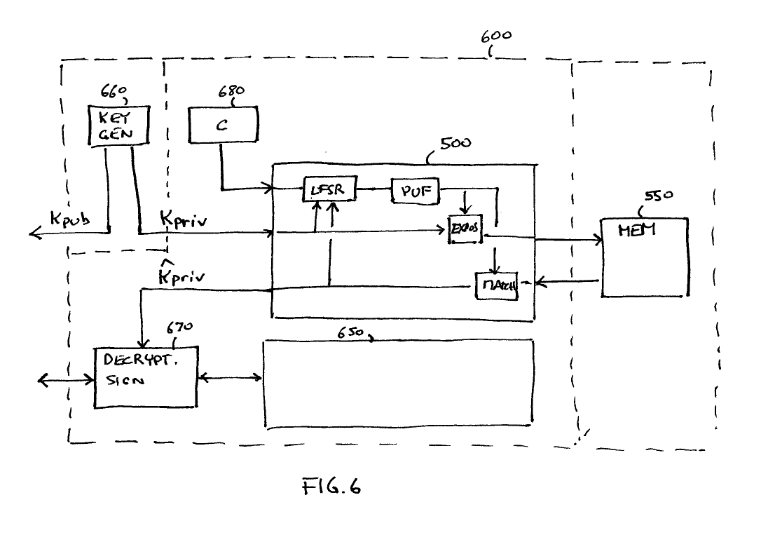

Referring to FIG. 6, an example of a device 600 (e.g., a radio frequency identification device, RFID, or other form of proximity or near-field device) includes a key generator 660, which generates a public and private key pair on the device, without exposing the private key. The device also includes a stored challenge value c, which may be exposed, or provisioned. The device includes a module 500, which takes the challenge, and the private key divided into a series of values, and generates a series of patterns that are stored in a memory 550, which may be on the device, or alternatively remote to the device. Later, in order to perform a cryptographic function requiring the private key, the device decodes the patterns in the memory 550 to reconstruct the private key. For example, the private key is used to decrypt communication received at the device encoded with the device's public key for processing in modules 650 on the device. As another example, the private key is used to sign a result produced on the device to prove that the device is authentic and/or that the result was truly produced on that device.

Note that in yet other examples, the key generator is not necessarily integrated onto the device, and a private or symmetric key is provide to the device for encoding during a provisioning procedure.

It should also be understood that other forms of statistically regeneratable (i.e., regeneratable with some errors) pseudo-random sequences can be used in this manner. For example, the result sequence may depend on biometric or physical measurements in addition to or rather than on device-specific circuit characteristics (e.g., delay characteristics).

In some implementations, modules or entire devices may be represented in data that imparts functionality onto a design or fabrication system. For example, a module may be represented though functional data and/or instructions of a hardware description language (e.g., HDL, Verilog, etc.), which is used to lay out and then fabricate devices that embody that module.

It is to be understood that the foregoing description is intended to illustrate and not to limit the scope of the invention. Other embodiments are within the scope of the following claims.

What is claimed is:

1. A method for securely maintaining a secret value based on device-specific characteristics of a device, the method comprising:
accepting the secret value;
in the device in a first phase, generating a device-specific pattern sequence, wherein the pattern sequence is statistically unique to the device;
selecting one or more offset values to represent the secret value, and determining selected patterns in the pattern sequence at the selected offset values; and
providing the selected patterns for maintenance in a storage associated with the device for use in subsequent regeneration of the secret value.

2. The method of claim 1 wherein generating the device specific pattern sequence comprises generating a bit sequence, wherein the patterns of the pattern sequence represent segments of the bit sequence.

3. The method of claim 1 wherein generating the device specific pattern sequence comprises applying a sequence of inputs to a Physical Unclonable Function (PUF) module, and forming the devices specific pattern sequence from the corresponding outputs of the PUF module.

4. The method of claim 1 further comprising:
accessing the maintained selected patterns from the storage associated with the device;
in the device in second phase, regenerating a device-specific pattern sequence, the patterns in the sequence being statistically similar to the patterns generated in the device in the first phase;
for each of the selected patterns from the storage, determining an offset in the regenerated pattern sequence at which the regenerated pattern corresponds to the pattern accessed from the storage;
forming the secret value from the determined offset of each of the maintained selected patterns.

5. A method for securely regenerating a secret value based on one or more maintained patterns, the method comprising:
accessing the maintained selected patterns from a storage associated with the device;
in the device, regenerating a device-specific pattern sequence, the patterns in the sequence being statistically similar to patterns of a prior pattern sequence generated in the device;
for each of the selected patterns from the storage, determining an offset in the regenerated pattern sequence at which the regenerated pattern corresponds to the pattern accessed from the storage;
forming the secret value from the determined offset of each of the maintained selected patterns.

6. The method of claim 4 wherein determining the offset in the regenerated pattern sequence at which the regenerated pattern corresponds to the pattern accessed from the storage includes determining whether the regenerated pattern matched the pattern from the storage within a predetermined degree of difference.

7. The method of claim 5 wherein the patterns are represented as bit sequences, and the predetermined degree of difference comprised as predetermined number of bit differences.

8. The method of claim 4 further comprising forming a plurality of parts of the secret value, and wherein each of the selected one or more offsets represents a different part of the secret value.

9. The method of claim 8 wherein generating the device specific pattern sequence comprises applying a sequence of inputs to a Physical Unclonable Function (PUF) module, and forming the devices specific pattern sequence from the corresponding outputs of the PUF module.

10. The method of claim 9 wherein the sequence of inputs depends on one or more parts of the secret value.

11. The method of claim 1 wherein the secret value comprises a cryptographic key.

12. The method of claim 11 wherein the cryptographic key comprises a symmetric key.

13. The method of claim 11 wherein the cryptographic key comprises a private key.

14. The method of claim 4 wherein the secret value comprises a cryptographic key, and the method further comprises using the cryptographic key to perform a function on the device.

15. A device comprising:
a pattern sequence generator for repeatedly generating a pattern sequence that is statistically unique to the device;
a pattern selector configured to accept a secret value, and select patterns in the pattern sequence according to one or more offsets determined from the secret value;
an interface for storing the selected patterns, and subsequence retrieval of the selected patterns;
a pattern matcher configured to retrieve the selected patterns and to determine offsets of the one or more patterns in a repeated generation of the pattern sequence; and
a value assembler for combining the determined offsets to assemble a regeneration of the secret value.

16. A software description of a circuit module comprising data embodied on a tangible machine readable medium for causing a processor to assemble the module into a device description, the circuit module comprising:
a pattern sequence generator for repeatedly generating a pattern sequence that is statistically unique to the device;
a pattern selector configured to accept a secret value, and select patterns in the pattern sequence according to one or more offsets determined from the secret value;
an interface for storing the selected patterns, and subsequence retrieval of the selected patterns;
a pattern matcher configured to retrieve the selected patterns and to determine offsets of the one or more patterns in a repeated generation of the pattern sequence; and
a value assembler for combining the determined offsets to assemble a regeneration of the secret value.
